(19) United States
(12) Patent Application Publication
(10) Pub. No.: US 2004/0041791 A1
(43) Pub. Date: Mar. 4, 2004

(54) Keyboard touchpad combination

(75) Inventor: Garrett Storm Dunker, Phoenix, AZ (US)

Correspondence Address: GARRETT STROM DUNKER, 5525 TENLEY PL., OWINGS, MD, 20736, US

(73) Assignees: Mr. Garrett Storm Dunker; SDSS Inc., Phenix, AZ

(21) Appl. No.: 10/064,935

(22) Filed: Aug. 30, 2002

(51) Int. Cl. G09G 5/00

(52) U.S. Cl. 345/168

(57) ABSTRACT

The preferred embodiment of the invention integrates touchpad cursor control, normally associated with portable computers, onto the top surfaces of keyboard keys. The keyboard keys are, themselves, a network of miniature touchpads. This design of cursor control allows the computer user access to cursor control without taking his or her fingers off the keyboard. The computer user will be able to type normally by pressing the keys down and then move the cursor by dragging a finger across the top surfaces of the keys. Using an intelligent touchpad or driver software, the computer recognizes a difference between a key that is being pressed and another that is being passed over.

### BACKGROUND OF INVENTION

The most common human-computer interface for signal input is the computer keyboard. Through widespread use of this hardware, several innovations have taken place to make keyboarding use more efficient and more comfortable. Yet, even despite these improvements, there is still a need for a cursor control device. Normally, to use a cursor control device, one's hand must leave the keyboard and physically grasp the cursor control device. Cursor control devices can vary in style and type from computer to computer but the keyboard fundamentals remain the same.

Existing methods of controlling the cursor without the fingers leaving the keyboard include a control means with a different member of the body, a visual cue sensor, or a miniature trackball worn as a ring on a forefinger. Each of these methods requires an additional hardware component and possesses operational characteristics largely different from common cursor input devices, such as mice, trackballs and touchpads.

The touchpad cursor control device, normally associated with portable computers, controls the cursor in response to a user dragging a finger in the intended direction of cursor travel on the screen. This eliminates the need for grasping any physical device but still involves removing a hand from the keyboard.

### SUMMARY OF INVENTION

It is the object of the invention to integrate a cursor control means for a corresponding computer and display screen onto a surface of a keyboard, such that the cursor is still controlled with the hand, only the hand no longer has to leave the keyboard.

In a first embodiment, the top surfaces of some or all keys on a keyboard are miniature touchpads. Not all keys must have miniature touchpads, for instance, only the keys surrounding home row would be sufficient. The touchpads are designed to collectively act as one much larger touchpad. Several accommodations will be necessary to do so. A first accommodation is a keyboard whose keys have less space between them, not necessarily a smaller keyboard, but a same size keyboard with larger keys and less spacing. The result is comparable to a single larger touchpad with small cracks. A second accommodation required is a method for networking each miniature touchpad to work with the other miniature touchpads as a whole. This is accomplished using software within the computer or a built-in electronic engineering solution within the keyboard. Yet another accommodation is the requirement for the keys' top surfaces to no longer be concaved. Normal keys are concaved to touch more of a fingers' surface area, whereby touchpads are flat. Thus, until flexible touchpads can be developed and prove functional, the key top surfaces in this embodiment will need to be flat or near flat.

At a time when a keyboard user desires to type, the individual positions his hands and fingers normally and types, in the traditional fashion, by depressing the desired keys. Typing normally is in reference to using all fingers on a keyboard that has keys positioned in the universal arrangement and such keys are depression activated keys. When the individual prefers to input using cursor control, instead of moving a hand to a separate cursor control device, the user keeps his hands and fingers in the same position and controls the cursor in a normal touchpad manner, similar to a portable computer, but using the top surfaces of the keyboard keys.

The touchpad functions of left, right, and double clicks are accommodated, other than physical click buttons, by a simple single tap or double tap at a specific location on the keyboard touchpad. Instead of having physical click buttons, this touchpad can have assigned areas dedicated to this specific function. A single tap on the left side of the keyboard touchpad would be indicative of a left click, a single tap on the right side of the keyboard touchpad would be indicative of a right click. Thus a double click would be a double tap. The user, however, needs to be careful to not tap so hard as to accidentally depress the key belonging to the touchpad. Stiffer key depression forces help prevent this from happening.

In a second embodiment, the user interface is a keyboard sized touchpad. The touchpad need not be the entire keyboard, the Home Row and surrounding alphabet portion does proves sufficient, but the preferred method of the second embodiment is the entire keypad containing the alphabet keys and adjacent keys. In this case, the touchpad has key outlines representing the characters of the traditional keys in their corresponding locations. In the event of a flexible touchpad, the exception of having keys that don't depress can then be accommodated.

At a time when a keyboard user desires to type, the individual positions his hands and fingers normally and types, unlike the traditional manner, by tapping the desired characters' specific location on the touchpad; no depression action is required. When the individual prefers to input using cursor control, still keeping his hands and fingers in the same location, the user simply operates the touchpad in the normal portable computer manner, by dragging a finger across the touchpad in the desired direction of cursor travel.

The touchpad functions of left, right, and double clicks are accommodated, other than physical click buttons, by a single tap or double tap at a specific location on the keyboard touchpad. In a first method, an intelligent keyboard, that capable of distinguishing a behavioral difference between cursor control and typing input, may be necessary. In another method, the inclusion of two additional tapping areas on the touchpad, extensions of the touchpad past the keyboard outline, allows for additional programmable functions. These additional tapping areas can be programmed to prescribe the specific function of left, right, and double clicks.

The scroll wheel function can be accommodated, for both embodiments, by using a scroll wheel placed at an ergonomic location on the board for minimal user discomfort, or by assigning a specific location on the touchpad, similar to the left and right click areas. Dragging a finger up or down, with respect to the keyboard, within this assigned area can equate a scroll up or scroll down, respectively.

While touchpad control is most commonly found on portable computers, the keyboard embodiments of the invention are not restricted to any style of computers.

These embodiments can be better understood when accompanying the following drawings and descriptions.

### BRIEF DESCRIPTION OF DRAWINGS

FIG. 1 is a perspective view of a keyboard with close fitted keys and touchpad key tops.

FIG. 2 is a perspective view of a keyboard with assigned areas for the left click, right click, and scroll functions.

FIG. 3 is a perspective view of a large touchpad with key outlines.

### DETAILED DESCRIPTION

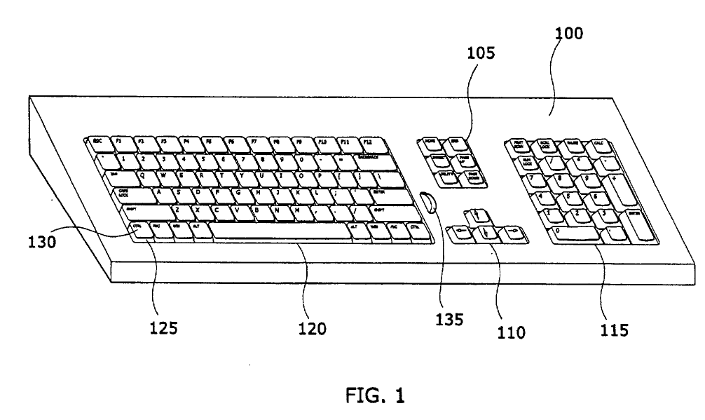

FIG. 1 shows the preferred embodiment as keyboard 1 00. Specific functional keys 105, arrow keys 110, and number pad 11 5 are positioned to the right of keypad 120, in their traditional locations, and are normal depression keys. Not all keys on keyboard 1 00 must have touchpad key tops to achieve satisfactory cursor control. Keypad 1 20 is compromised of a network of miniature touchpads on the surfaces of each key. The top surface of keyboard key 125 is a miniature touchpad 1 30. The act of depressing key 125 serves as the input signal for the corresponding character of that key, and the act of dragging a finger across the key acts as cursor input via the miniature touchpad 130. Scroll wheel 1 35 is positioned just to the right of keypad 120 and requires minimum hand movement off the keyboard.

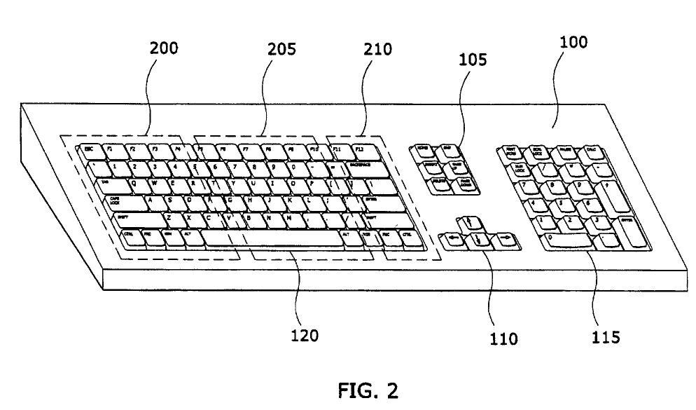

The touchpad functions of scroll, left, right, and double clicks of keyboard 1 00 can be accommodated using the methods shown in FIG. 2. Keyboard 1 00 is shown with three specific function zones over the area of keypad 1 20. Zone 200 corresponds to a left click. A single tap in this area equates the input of a left click; a double tap in this area equates the input of a double left click. Zone 205 corresponds to a right click. A single tap in this area equates the input of a right click. Zone 210 corresponds to the scrolling function. Dragging a finger up or down, with respect to the keyboard 1 00, equates the input of scrolling up or down, respectively. It is noted that the area in zone 210 can not also serve as a cursor control since the dragging motion equates two different functions. Zone 210 is reserved specifically for the scroll function. If a scroll wheel were featured, the zone 21 0 restriction would no longer be in place.

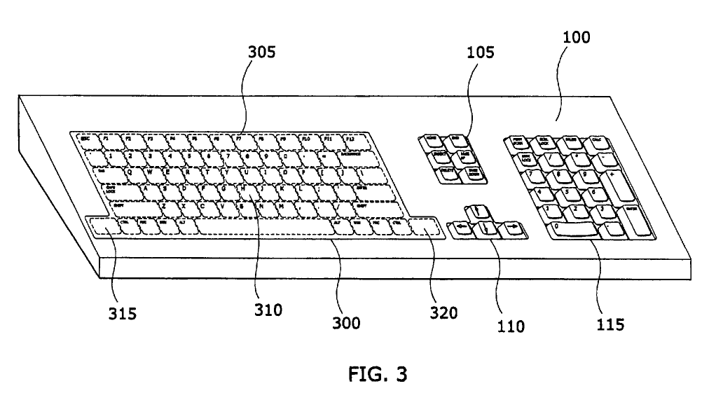

FIG. 3 shows keyboard 100 in the second embodiment, a touchpad 300 with key outlines 305. Specific function keys 11 0, arrow keys 11 5, and number keypad 1 20 are positioned to the right of touchpad 300 in their normal locations and are normal depression keys. Key outlines 305 are outlines of keyboard keys having the shape, size, and characters of a normal keyboard. Under this method, tapping a finger on the touchpad at the specific location “H” 310 equates the specific function equivalent to depressing the “H” key on a traditional keyboard. Touchpad 300 also operates as a normal touchpad, whereby controlling a cursor is done in the manner of dragging a finger and selecting onscreen items are done by single or double tapping. An intelligent touchpad, that capable of determining the differences in operational characteristics of dragging, single tapping, double tapping, and typing, is required if click buttons or the additional tapping areas are not included. These additional tapping areas, though optional, are shown as additional tapping area 31 5 and additional tapping area 320 to the left and right of touchpad 300, respectively. Additional tapping area 315 has the specific function of the left click input and additional tapping area 320 has the specific function of the right click input.

1. A touchpad network comprising:
(a) a plurality of touchpads;
(b) a method for networking said touchpads to perform as a single larger touchpad.

2. A touchpad, coupled to a computer and display screen, comprising:
(a) a first input controlling mode, said first controlling mode dictates cursor movement on said display screen via a dragging motion across the surface of said touchpad;
(b) a second input controlling mode, said second controlling mode assigns specific input functions to specific locations on said touchpad;
where said specific input functions are initiated by tapping said specific location on said touchpad, and said tapping action and said corresponding specific input functions do not interfere with the input of said dragging motion and said corresponding cursor movement, and said dragging motion and said corresponding cursor movement does not interfere with said tapping action and said corresponding specific input functions.

3. A human computer keyboard interface device combined with the touchpad network of claim 1, comprising:
(a) a plurality of keyboard keys, a portion of said keyboard keys coupled to a touchpad, said touchpad being the top surface of said keys;
(b) a method indicating to a computer and display screen a distinguishable difference in user patterns for keyboarding input and cursor input such that said keyboarding input does not interfere with said cursor input and said cursor input does not interfere with said keyboarding input.

4. A human computer keyboard interface device combined with the touchpad network of claim 1, comprising:
(a) a plurality of keyboard keys, each of said keyboard keys coupled to a touchpad, said touchpad being the top surface of said keys;
(b) a method indicating to a computer and display screen a distinguishable difference in user patterns for keyboarding input and cursor input such that said keyboarding input does not interfere with said cursor input and said cursor input does not interfere with said keyboarding input.

5. A touchpad interface device, as in claim 2, where said second input controlling modes' said specific input functions are those of a typing keyboard functions and comprising:
(a) a plurality of keyboard key outlines, each of said keyboard keys outlines located on the surface of said touchpad interface device, and said tapping action within said outlines equates the function of the corresponding keyboard key input;
(b) a method indicating to said computer and display screen a distinguishable difference in user patterns for keyboarding input and cursor input such that said keyboarding input does not interfere with said cursor input and said cursor input does not interfere with said keyboarding input.
